(19) United States
(12) Patent Application Publication
(10) Pub. No.: US 2022/0091326 A1
(43) Pub. Date: Mar. 24, 2022

(54) OPTICAL LIGHT GUIDE INCLUDING FLUORESCENT MATERIAL

(71) Applicant: SAINT-GOBAIN CERAMICS & PLASTICS, INC., Worcester, MA (US)

(72) Inventor: Peter R. MENGE, Novelty, OH (US)

(21) Appl. No.: 17/447,755

(22) Filed: Sep. 15, 2021

Related U.S. Application Data
(60) Provisional application No. 63/081,034, filed on Sep. 21, 2020.

(51) Int. Cl. G02B 6/02; F21V 8/00; G02B 6/42

(52) U.S. Cl. CPC G02B 6/02038; G02B 6/0008; B42D 25/30; G02B 6/0003; G02B 6/4298

(57) ABSTRACT

A substrate can include an optical light guide including a core. The core can include a fluorescent material in a content of greater than 0.5 wt. % for the total weight of the core. In an embodiment, the optical light guide can include a scintillator material. In another embodiment the core can include polyethylene naphthalate (PEN) and a polyvinylidene difluoride cladding.

### CROSS-REFERENCE TO RELATED APPLICATION(S)

This application claims priority under 35 U.S.C § 119(e) to U.S. Provisional Application No. 63/081,034, entitled “OPTICAL LIGHT GUIDE INCLUDING FLUORESCENT MATERIAL,” by Peter R. MENGE, filed Sep. 21, 2020, which is assigned to the current assignee hereof and is incorporated by reference in its entirety.

### FIELD OF THE DISCLOSURE

The application relates to a substrate including an optical light guide including a fluorescent material.

### BACKGROUND

Many valuable items such as paper currency contain anti-counterfeiting labels. Anti-counterfeiting labels should be easy to read, but difficult to replicate. Scintillating material can be used within security applications, such as anti-counterfeiting labels, to produce a desired optical and radiation-resistance characteristic. However, scintillation materials as well as other optical fiber materials have traditionally been limited by the properties of the materials used—as one property is enhanced while another is compromised—and thus can be quite challenging to manufacture. As such, as counterfeiters become more sophisticated, there is a continuous need to change and update anti-counterfeiting modalities.

### BRIEF DESCRIPTION OF THE DRAWINGS

Embodiments are illustrated by way of example and are not limited in the accompanying figures.

FIG. 1 includes an illustration of an optical light guide according to an embodiment.

FIG. 2 includes an illustration of an optical light guide according to another embodiment.

FIG. 3 includes an illustration of a substrate according to an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific embodiments and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

Embodiments relate to a substrate including an optical light guide including a fluorescent material. An exemplary substrate can include a valuable paper or cloth item, and the optical light guide can be disposed in the substrate and serve as an anti-counterfeiting device. The optical light guide can be suited to provide an overt feature directly detectable by human eyes in various ambient lighting conditions. Particularly, in some applications, the optical light guide can generate a sufficient amount of visible light that can be detected directly by human eyes to allow authentication of the substrate in dim ambient light.

Any of the optical light guides as described below can be used in a variety of applications. Exemplary applications include gamma ray spectroscopy, isotope identification, Single Photon Emission Computer Tomography (SPECT) or Positron Emission Tomography (PET) analysis, x-ray imaging, oil well-logging detectors, medical imaging devices, network communications device, high energy physics, small detectors, network communications, broadcast receivers, wireless transmissions, augmented reality devices, broadcasting networks, security devices, anti-counterfeiting, and detecting the presence of radioactivity. The optical light guide can be used for other applications, and thus, the list is merely exemplary and not limiting. A couple of specific applications are described below.

Embodiments described below and illustrated are provided to aid in understand the concepts as set forth herein. The embodiments are merely illustrative and not intended to limit the scope of the present invention, as set forth in the appended claims.

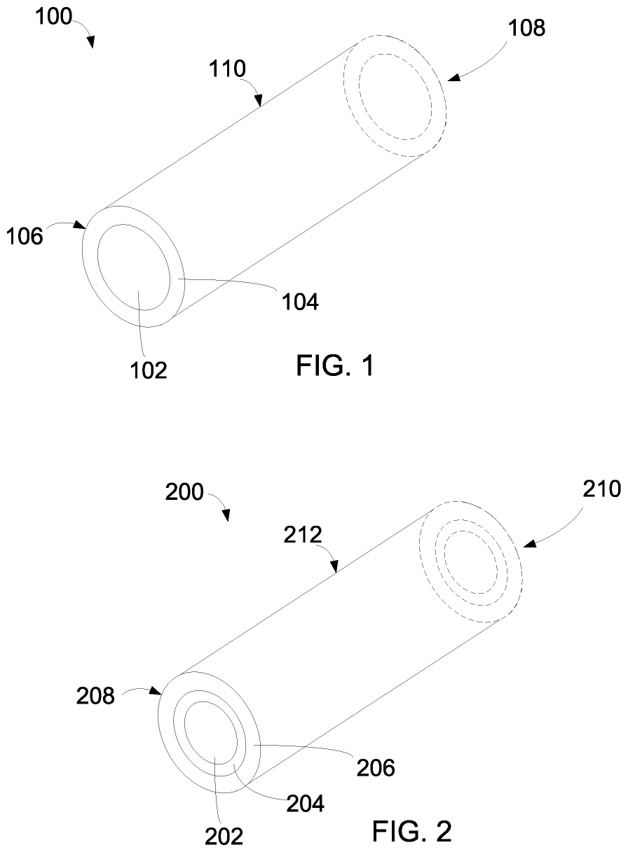

FIG. 1 includes an illustration of an exemplary optical light guide 100, including the core 102 and cladding 104. In an embodiment the optical light guide can be an optical light guide, an optical ribbon, a wavelength shifting fiber, or any combination thereof. In an embodiment, the optical light guide can include a cladding or a coating, wherein the cladding or coating can at least partially surround the core. In an embodiment, the optical light guide can include at least one cladding. The cladding 104 can abut the core and surround substantially the entire core. In an embodiment, the optical light guide can include a core including a fluorescent material. In an embodiment, the fluorescent material can be present in the core in a particular content that can improve radiation adsorption and detectability of light generated by the optical light guide. For instance, the fluorescent material can be present in the core in the content greater than 0.1 wt. % for the total weight of the core, such as at least 0.5 wt. %, or at least 1 wt. %, at least 5 wt. % or at least 10 wt. %, or at least 10 wt. %, at least 13 wt. %, at least 15 wt. %, at least 17 wt. %, at least 20 wt. %, at least 23 wt. %, or at least 25 wt. % for a total weight of the core. In another instance, the core can include the fluorescent material in a content of at most 40 wt. % for the total weight of the core, such as at most 37 wt. %, at most 35 wt. %, or at most 33 wt. % for a total weight of the core. Moreover, the core can include a content of the fluorescent material in a range including any of the minimum and maximum values noted herein. For example, the core can include the fluorescent material in a range greater than 0.1 wt. % to 40 wt. % for the total weight of the core.

In an embodiment, the fluorescent material can generate visible light, having a wavelength in a range from 350 nm to 750 nm. For example, the fluorescent material can generate green light (520 nm to 560 nm), blue light (450 nm to 490 nm), cyan light (490 nm to 520 nm), red light (625 nm to 700 nm), or light in other colors. In particular applications, the core can include the fluorescent material that can generate green light.

In an embodiment, the fluorescent material can be sensitive to a targeted electromagnetic radiation, and in response to absorbing the electromagnetic radiation, the fluorescent material can reemit light. An exemplary electromagnetic radiation can include ultra violet light having a wavelength in a range from 10 nm to 400 nm, certain visible light, such as blue light, or another radiation.

In an embodiment, the core can include one or more fluorescent material. For example, in some applications, the core can include a single fluorescent material. In other embodiments, the core can include different fluorescent materials. In particular instances, the different fluorescent materials can generate visible light having the same color, such as in the same wavelength range noted for the color. For instance, the different fluorescent materials can all generate green light or red light or another light selected to suit particular applications. In a further example, the different fluorescent material can be sensitive to different or the same electromagnetic radiation.

In some applications, the different fluorescent materials in the core can generate light in different colors. For instance, the combination of the colors can create a predetermined color or shade to facilitate authentication of the substrate. In further instances, at least one or each of the different fluorescent materials can be present in the core in the content noted in embodiments herein. Furthermore, the content of each fluorescent material can be selected to create the predetermined light color or shade.

In another embodiment, the fluorescent material can include a wavelength shifting material that is capable of absorbing an electromagnetic radiation having a first wavelength and reemitting a second light having a second wavelength different than the first wavelength. For instance, the second wavelength can be longer than the first wavelength. In a particular instance, the fluorescent material can be sensitive to an ultra violet light and reemit visible light. In another particular instance, the fluorescent material can be sensitive to blue light and reemitting light having a wavelength longer than blue light, such as green or red.

In an embodiment, the fluorescent material can include an organic material, such as a polymer, an inorganic compound, a small molecule, an organosilicon compound, an organo-metallic compound, a chelate, a triplet harvesting organic compound, or any combination thereof. An exemplary small molecule can include olitoarysilane, p-terphenyl (C₁₈H₁₄), 2,5-diphenyloxazole (PPO, C₁₅H₁₁NO), 1,1,4,4,-tetraphenylbutadiene (TBP, C₂₈H₂₂), 1,2,4-trimethyl benzene (C₉H₁₂), dimethyl stilbene (DPS, C₂₆H₁₈), bis-MSB (C₂₄H₂₂), dimethyl POPOP (C₂₆H₂₀N₂O), K27 (C₂₃H₁₉NO₄), tris [1-phenylisoquinolinato] iridum (III) (C₁₅NlrH₁₀), Indolcarbonsaureester (C₂₃H₁₉NO₄), or any combination thereof. An exemplary organosilicon compound can include an oligoarylsilane with a composition elemental weight fractions of: C-63%, H-5%, Si-7%, S-21%, and N-4% or C-70%, H-5%, Si-12%, S-8%, and N-4%.

In another embodiment, the core can include a scintillator material that is sensitive to a targeted electromagnetic radiation. The scintillator material can produce scintillation light in response to receiving the targeted radiation. In an embodiment, the targeted radiation can include any of those noted in embodiments of this disclosure. In a particular embodiment, the scintillator material can be sensitive to the ultra violet light. In another embodiment, the scintillator material can produce a visible light, such as blue light, or scintillation light having a wavelength outside of the range of visible light, in response to receiving the targeted radiation. In at least one particular embodiment, the scintillator material can produce an electromagnetic radiation that can be absorbed by the fluorescent material for the fluorescent material to produce visible light.

In an embodiment, the scintillator material can include a polymer, such as a plastic material. A particular example of the polymer can include a material selected from the group consisting of polyacrylate, such as polymethylmethacrylate (PMMA), a polystyrene, a polyvinyltoluene, polyester, polyamide, polypropylene, polyethylene naphthalate (PEN), or another suitable light-transmitting polymer. In some exemplary applications, the core can include polystyrene. In at least one example, the core may be substantially free of polyacrylate. In some particular embodiments, the core can include light transmitting polyester, polyamide, polypropylene, or a combination thereof. The core 102 may be various geometric shapes such as round, square, triangular, polygonal, or hexagonal. The core 102 may have a diameter of 10 microns to 80 microns. In one embodiment, the luminescent fiber has a thickness of less than 80 microns, such as less than 50 microns, or less than 40 microns, or less than 30 microns.

In an embodiment, the core can include a transparent organic material having improved chemical resistance and mechanical properties that can improve formation of the substrate and properties of the optical light guide. In an exemplary application, the substrate can be a banknote, and the optical light guide can be embedded within the banknote. High chemical resistance and improved mechanical properties can help the optical light guide survive the forming process of the banknote and improve resistance to wear and tear caused by the use of the banknote. Authentication reliability of the optical light guide also can be improved. In an embodiment, an example of a suitable organic material can include a light-transmitting polymer including, for instance, polyester, polyamide, polypropylene, or a combination thereof.

In an embodiment, the core can include a material having a particular refractive index that can facilitate improved detectability of light generated by the optical light guide. In an embodiment, the refractive index can be at least 1.45, at least 1.50, at least 1.55, or at least 1.60. For instance, polystyrene has a refractive index of 1.60, and polyamide and polypropylene has a refractive index of 1.55 and 1.50, respectively. In another embodiment, the refractive index can be at most 1.80, at most 1.75, or at most 1.70. Moreover, the core can include a material with a refractive index in a range including any of the minimum and maximum values noted herein.

In an embodiment, the core can consist essentially of an organic material. In another embodiment, the core can include a matrix of the scintillator material, and the fluorescent material can be dispersed within the matrix. In a particular embodiment, the core can consist essentially of the scintillator material and the fluorescent material.

In an embodiment, the core can have a particular refractive index that can facilitate improved detectability of light produced by the optical light guide. In an embodiment, the refractive index can be at least 1.45, at least 1.50, at least 1.55, or at least 1.60. In another embodiment, the refractive index can be at most 1.80 or at most 1.75 or at most 1.70. Moreover, the refractive index of the core can be in a range including any of the minimum and maximum values noted herein.

FIG. 2 includes an illustration of another exemplary optical light guide 200 including the core 202, a first cladding 204 surrounding the core 202, and a second cladding 206 surrounding the cladding 204. In another example, the optical light guide 200 may include one or additional claddings (not illustrated). In an embodiment, the cladding can include a different material compared to the core of the optical light guide. In another embodiment, the optical light guide can include claddings formed of different materials.

In a further embodiment, a cladding (e.g., cladding 104, 204, or 206) can have a different refractive index compared to its core (e.g., 102 or 202), and claddings 204 and 206 can have different refractive indices. In a particular embodiment, a cladding can have a refractive index less than the refractive index of its core. In another particular embodiment, compared to an inner cladding, such as 204, an outer cladding, such as 206, can have a smaller refractive index.

In an embodiment, a cladding can have a refractive index of at most 1.50, at most 1.40, or at most 1.35. In another instance, a cladding can have a refractive index of at least 1.00, at least 1.10, or at least 1.20. In a further instance, a cladding can have a refractive index including any of the minimum and maximum values noted herein. In a further embodiment, the difference of the refractive indices between a cladding and the core of an optical light guide can have an absolute value of at least 0.1, at least 0.2, or at least 0.3. In one embodiment, the cladding has a refractive index that is lower than the refractive index of the core.

In some particular applications, an outermost cladding of an optical light guide, such as 104 and 206, can have a relatively low refractive index that can improve photon trapping efficiency of the optical light guide. For instance, an outermost cladding can have a refractive index of at most 1.40, at most 1.35, or even at most 1.30.

In an embodiment, the optical light guide can produce an irradiance of >4 mW/mm² of optical power emission out the ends of the fiber when illuminated with 50 mW/mm2 of light composed of a wavelength of 470 nm. Irradiance is measured using a system that includes a planar blue LED black light with output of 50.0 mW/cm2 emitting over a spectrum of between 455 nm and 485 nm. A ribbon is mounted to a piece of polyester with one piece of black tape attached at the far end of the ribbon or fiber. The fiber or ribbon is laid directly on the LED. An aperture is used to align the fiber or ribbon with the integrating sphere. In an embodiment, the optical light guide can produce and irradiance of less than 15 mW/mm², such as 10 mW/mm², or such as 8 mW/mm² of optical power emission out the ends of the fiber when illuminated with 50 mW/mm² of light composed of a wavelength of 470 nm.

In an embodiment, the optical light guide can have a particular photon trapping efficiency that can facilitate improved detectability of light produced by the optical light guide. For instance, the optical light guide can have a trapping efficiency η of at least 11%, such as at least 12%, at least 13%, at least 14%, or at least 15%. In another instance, the photon trapping efficiency can be at most 20%, or at most 17%. In a further instance, the photon trapping efficiency can be in a range including any of the minimum and maximum percentages noted herein.

Photon trapping efficiency of the optical light guide for a circular fiber can be determined by using Formula 1 below, where η is the fraction of trapped photons, n_{clad} is the refractive index of the outermost cladding, and n_{core} is the refractive index of the core.

$$η = \frac{1}{2} [ 1 - {( \frac{{n}_{clad}}{{n}_{core}} )}^{2} ]$$

In an embodiment, the cladding can include an organic material, such as a polymer. In another embodiment, the cladding, such as the outermost cladding, can include a material having improved chemical resistance and mechanical properties that can facilitate improved formation of the substrate and improved properties of the optical light guide. A particular example of the cladding material can include a high-performance polymer, such as a fluoropolymer or the like. Exemplary fluoropolymer can include ethylene tetrafluoroethylene (ETFE), perfluoroalkoxy (PFA), polytetrafluoroethylene (PTFE), derivatives thereof, or any of the functionalized fluoropolymers thereof, or any combination thereof. In some particular applications, the cladding can include an amorphous PTFE.

In another embodiment, the cladding can consist essentially of a fluoropolymer. For instance, the cladding can consist essentially of ETFE. In another instance, the cladding can consist essentially of PFA. In another instance, the cladding can consist essentially of amorphous PTFE. In one instance, the cladding may be essentially free of fluoro-acrylate. In another instance, the cladding can be essentially free of the fluorescent material.

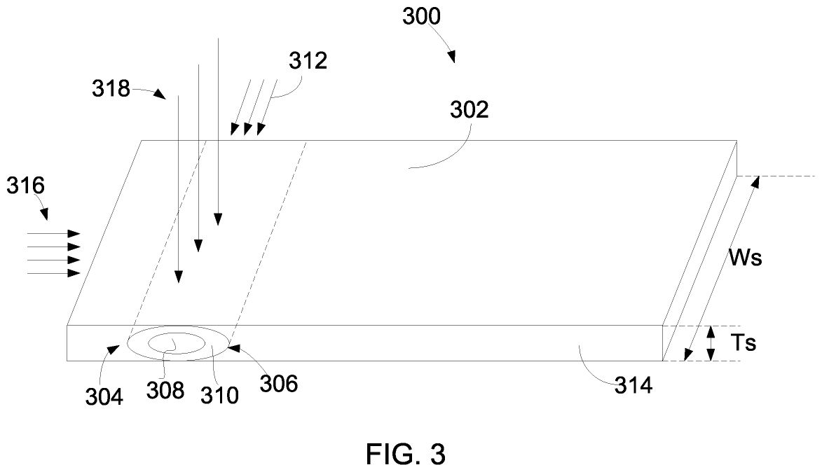

FIG. 3 includes an illustration of an exemplary substrate 300, where the optical light guide 304 is embedded in the substrate. The substrate 300 can have a first major surface 302 and a second major surface opposite the first 302 (not illustrated), and the optical light guide can be embedded between the major surfaces. The optical light guide 304 can include an end surface 306 aligned with the edge 314 of the substrate 300. The other end surface that is opposite the end surface 306 (not illustrated) can be aligned with the other edge opposite the edge 314 of the substrate 300. Both end surfaces of the optical light guide can be exposed to the outer environment.

In an exemplary application, one of the end surface (referred to as “radiation-receiving end” hereinafter) can be exposed to a targeted radiation 312 as illustrated in FIG. 3, such as an ultra violet radiation source, and visible light, such as green light, can be detected from the other end surface (referred to as “light-exiting end” hereinafter), such as the end surface 306, as illustrated in FIG. 3.

The substrate 300 can have a thickness, Ts, extending between the major surfaces and a width, Ws. The optical light guide 304 can be disposed across the width Ws of the substrate. In another instance, the optical light guide 304 can be disposed across the length of the substrate that extends in parallel with the edge 314. The optical light guide can have a thickness To that is smaller than the thickness Ts of the substrate.

In an embodiment, the cross section of the optical light guide can have a particular shape. For instance, the cross section can be a circle, a rectangle, a square, a triangle, or the like. Accordingly, the thickness of the optical light guide can correspond to the smallest dimension of the cross section that extends in the same direction as the thickness of the substrate. For instance, the thickness can be the diameter of the circle. In another instance, the thickness can be the width of the rectangle or square. In another instance, the thickness can be a height of the triangle.

In an embodiment, the optical light guide can have a particular thickness that can facilitate improved formation of the substrate. For instance, the optical light guide can have a thickness of at most 40 microns, such as at most 35 microns, or at most 30 microns. In another instance, the optical light guide can have a thickness of at least 10 microns, such as at least 20 microns, at least 25 microns, or at least 30 microns. In a further instance, the thickness of the optical light guide can be in a range including any of the minimum and maximum values noted herein. For instance, the optical light guide can include a thickness from 10 microns to 40 microns.

In an embodiment, the substrate can include a single optical light guide. The optical light guide can respond to a targeted electromagnetic radiation and provide an overt feature. In an embodiment, the overt feature can include visible light produced by the optical light guide in response to receiving the targeted radiation. In a further embodiment, the overt feature can be directly detectable by human eyes. In an embodiment, detectability of the light by human eyes can be used to authenticate the substrate. For instance, if the predetermined colored light is visible, the identity of the substrate is true; and if the predetermined colored light is not visible, the identity of the substrate is false.

In another embodiment, a plurality of optical light guides can be disposed in the substrate. In an embodiment, the optical light guides can abut each other. In another embodiment, at least some of the optical light guides can be spaced apart from one another. In a particular embodiment, the optical light guides can be disposed such that the light produced by the optical light guides can form a predetermined pattern. In a further embodiment, the overt feature can include the predetermined pattern, and in some more particular instances, the predetermined pattern can be directly detectable by human eyes.

In some instances, the predetermined pattern can be utilized to authenticate the substrate. For instance, if the predetermined pattern is visible to human eyes, the identity of the substrate is true; and if the predetermined pattern is not detectable by human eyes, the identity of the substrate is false. In other instances, the predetermined pattern may be utilized to indicate value of the substrate, such as monetary value of banknotes. In a further embodiment, the predetermined pattern can include a combination of light colors, a shape formed by light, or a combination thereof.

In an embodiment, the substrate can include paper, currency, bond, cloth, fiber, plastics, or any combination hereof. In an embodiment, the optical light guide can be pressed, adhered, sewn, or weaved to the substrate. In another embodiment, an object including the substrate can include clothing, bag, purse, chip, card, or any combination thereof. In another embodiment, the optical light guide can be a part of a security document such as a passport, identification card, security feature within currency, clothing, or other weaved material. In an embodiment, authentication of the object can be performed utilizing the overt feature provided by the optical light guide.

Many different embodiments are possible. Some of those embodiments and aspects are described herein. After reading this specification, skilled artisans will appreciate that those embodiments are only illustrative and do not limit the scope of the present invention. Embodiments may be in accordance with any one or more of the items as listed below.

Embodiment 1. An optical light guide can include a core including a fluorescent material, where the fluorescent material is in a content of greater than 0.5 wt. % for a total weight of the core.

Embodiment 2. The optical light guide of embodiment 1, where the core includes polyethylene naphthalate (PEN).

Embodiment 3. The optical light guide of embodiment 2, further including a cladding, where the cladding includes polyvinylidene difluoride.

Embodiment 4. The optical light guide of embodiment 2, where the fluorescent material is in a content of between 0.6 wt. % and 1.4 wt. % for a total weight of the core.

Embodiment 5. The optical light guide of embodiment 1, where the optical light guide has at least one dimension of height, width, or diameter that is less than 40 microns.

Embodiment 6. The optical light guide of embodiment 1, where the optical light guide produces>4 mW/mm² of optical power emission out at least one end of the optical light guide when illuminated with 50 mW/mm² of light composed of a wavelength of 470 nm.

Embodiment 7. The optical light guide of embodiment 5, where the scintillator material is responsive to an ultra violet light.

Embodiment 8. The optical light guide of any of embodiments 1 to 3, where the fluorescent material includes a wavelength shifting material.

Embodiment 9. The optical light guide of any of embodiments 2 to 7, where the fluorescent material is capable of absorbing the first light produced by the scintillator material and reemitting a second light.

Embodiment 10. The optical light guide of embodiment 7, where the second light has a wavelength in a range from 350 nm to 750 nm.

Embodiment 11. The optical light guide of embodiment 7 or 8, where the fluorescent material is capable of reemitting a green light.

Embodiment 12. The optical light guide of any of embodiments 1 to 11, where the fluorescent material is in the content of at least 0.5 wt. %, 10 wt. %, at least 15 wt. %, at least 17%, at least 20 wt. %, at least 23 wt. %, or at least 25 wt. % for a total weight of the core.

Embodiment 13. The optical light guide of any of embodiments 1 to 11, where the fluorescent material is in the content of at most 40 wt. %, at most 37 wt. %, at most 35 wt. %, or at most 33 wt. % for a total weight of the core.

Embodiment 14. The optical light guide of any of embodiments 1 to 13, where the optical light guide has a thickness of at most 40 microns, at most 35 microns, or at most 30 microns.

Embodiment 15. The optical light guide of any of embodiments 1 to 13, where the optical light guide has a thickness of at least 20 microns, at least 25 microns, or at least 30 microns.

Embodiment 16. The optical light guide of any of embodiments 1 to 15, where the fluorescent material includes an inorganic compound.

Embodiment 17. The optical light guide of any of embodiments 1 to 16, where the fluorescent material includes an organic material.

Embodiment 18. The optical light guide of any of embodiments 1 to 17, where the fluorescent material includes an organosilicon compound, an organo-metallic compound, or a triplet harvesting organic compound.

Embodiment 19. The optical light guide of any of embodiments 1 to 18, where the fluorescent material includes a chelate.

Embodiment 20. The optical light guide of any of embodiments 1 to 15, where the fluorescent material includes p-terphenyl (C₁₈H₁₄), 2,5-diphenyloxazole (PPO, C₁₅H₁₁NO), 1,1,4,4,-tetraphenylbutadiene (TBP, C₂₈H₂₂), 1,2,4-trimethyl benzene (C₉H₁₂), Indolcarbonasureester (C₂₃H₁₉NO₄), dimethyl stilbene (DPS, C₂₆H₁₈), bis-MSB (C₂₄H₂₂), dimethyl POPOP (C₂₆H₂₀N₂O), K27 (C₂₃H₁₉NO₄), or tris [1-phenylisoquinolinato] iridium (III) (C₁₅NlrH₁₀).

Embodiment 21. The optical light guide of any of embodiments 1 to 20, where the core includes a polymer.

Embodiment 22. The optical light guide of any of embodiments 1 to 21, where the core includes polystyrene, polyacrylate, polymethylmethacrylate, polyvinyltoluene, polyethylene naphthalate (PEN), or any combination thereof.

Embodiment 23. The optical light guide of embodiment 1, where the core includes a scintillator material that is capable of producing a first light in response to receiving a radiation.

Embodiment 24. The optical light guide of any of embodiments 1 to 17, where the core has a refractive index of at least 1.45, at least 1.50, at least 1.55, or at least 1.60.

Embodiment 25. The optical light guide of any of embodiments 1 to 17, further including a cladding layer, where the cladding layer is disposed at least partially surrounding the core.

Embodiment 26. The optical light guide of embodiment 25, where the cladding layer has a refractive index less than the refractive index of the core.

Embodiment 27. The optical light guide of any of embodiments 25 or 26, where the optical light guide includes a refractive index difference between the core and the cladding layer, where an absolute value of the difference is at least 0.1, at least 0.2, or at least 0.3.

Embodiment 28. The optical light guide of any of embodiments 25 to 27, where the cladding layer has a refractive index of at most 1.40, at most 1.35, or at most 1.30.

Embodiment 29. The optical light guide of any of embodiments 25 to 28, where the cladding layer includes a fluoropolymer.

Embodiment 30. The optical light guide of any of embodiments 25 to 29, where the cladding layer consists essentially of a fluoropolymer.

Embodiment 31. The optical light guide of any of embodiments 25 to 26, where the fluoropolymer includes ethylene tetrafluoroethylene (ETFE), perfluoroalkoxy (PFA), polytetrafluoroethylene (PTFE), or any combination thereof.

Embodiment 32. The optical light guide of any of embodiments 25 to 27, where the fluoropolymer includes amorphous polytetrafluoroethylene (PTFE).

Embodiment 33. The optical light guide of any of embodiments 1 to 28, where the optical light guide has a light trapping efficiency of at least 11%, at least 12%, at least 13%, at least 14%, or at least 15%.

Embodiment 34. The optical light guide of any of embodiments 1 to 29, where the optical light guide is embedded within a security document.

Embodiment 35. The optical light guide of embodiment 34, where the optical light guide is disposed across a width of the security document.

Embodiment 36. The optical light guide of any of embodiments 1 to 31, where the optical light guide includes a radiation receiving end and a light exiting end, where at least the light exiting end is exposed to an outer environment.

Embodiment 37. The optical light guide of embodiment 36, where the light-exiting end is aligned with an edge of the substrate, and the radiation-receiving end is aligned with an opposite edge of the substrate.

Embodiment 38. The optical light guide of any of embodiments 1 to 37, where a cross-section of the optical light guide includes a shape of a circle, an oval, a rectangle, a square, or a triangle.

Embodiment 39. The optical light guide of any of embodiments 1 to 38, including a plurality of optical light guides disposed in a predetermined pattern.

Embodiment 40. The optical light guide of embodiment 39, where the plurality of optical light guides comprise different fluorescent materials.

Embodiment 41. The optical light guide of embodiment 39, where the plurality of optical light guides comprise the same fluorescent material.

Embodiment 42. The optical light guide of any of embodiments 1 to 37, where the scintillator material is not sensitive to a visible light.

Embodiment 43. The optical light guide of any of embodiments 1 to 38, where the optical light guide is within paper, cloth, plastics, currency, bond, security documents, passports, identification card, or any combination hereof.

Embodiment 44. An object, including the optical light guide of any of embodiments 1 to 38, where the object includes clothing, bag, purse, chip, card, security document, passport, identification card, or any combination thereof.

Embodiment 45. An anti-counterfeiting paper, including a layer structure; and an optical light guide within the layer structure, where the optical light guide includes a core including a fluorescent material, where the fluorescent material is in a content of greater than 0.5 wt. % for a total weight of the core.

The present embodiments represent a departure from the state of the art. Embodiments relate to a substrate including a particular optical light guide. For instance, compared to a conventional optical light guide, the optical light guide noted in embodiments herein can include a significantly higher content of a fluorescent material (greater than 10 wt. %). The particular content of the fluorescent material can help improve radiation absorption. In applications where the optical light guide has a small thickness (e.g., at most 40 microns), and thus, radiation has a much higher chance to pass through the optical light guide, improved radiation absorption can be expected to significantly improve the amount of light generated by the optical light guide and improve detectability of the overt feature by human eyes. Furthermore, in combination with improved radiation adsorption, improved photon trapping efficiency, higher chemical resistance and mechanical properties, or the combination thereof can allow the optical light guide to have improved properties and to provide an overt feature that that can be directly detected by human eyes in various ambient lighting conditions.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An optical light guide, comprising a core including a fluorescent material, wherein the fluorescent material is in a content of greater than 0.5 wt. % for a total weight of the core.

2. The optical light guide of claim 1, wherein the core comprises polyethylene naphthalate (PEN).

3. The optical light guide of claim 2, further comprising a cladding, wherein the cladding comprises polyvinylidene difluoride.

4. The optical light guide of claim 2, wherein the fluorescent material is in a content of between 0.6 wt. % and 1.4 wt. % for a total weight of the core.

5. The optical light guide of claim 1, wherein the optical light guide has at least one dimension of height, width, or diameter that is less than 40 microns.

6. The optical light guide of claim 1, wherein the optical light guide produces>4 mW/mm² of optical power emission out at least one end of the optical light guide when illuminated with 50 mW/mm² of light composed of a wavelength of 470 nm.

7. The optical light guide of claim 1, wherein the fluorescent material comprises a wavelength shifting material.

8. The optical light guide of claim 1, wherein the fluorescent material is in the content of at least 0.5 wt. % and at most 40 wt. % for a total weight of the core.

9. The optical light guide of claim 1, wherein the optical light guide has a thickness of at least 20 microns and at most 40 microns.

10. The optical light guide of claim 1, wherein the fluorescent material comprises p-terphenyl (C₁₈H₁₄), 2,5-diphenyloxazole (PPO, C₁₅H₁₁NO), 1,1,4,4,-tetraphenylbutadiene (TBP, C₂₈H₂₂), 1,2,4-trimethyl benzene (C₉H₁₂), Indolcarbonasureester (C₂₃H₁₉NO₄), dimethyl stilbene (DP S, C₂₆H₁₈), bis-MSB (C₂₄H₂₂), dimethyl POPOP (C₂₆H₂₀N₂O), K27 (C₂₃H₁₉NO₄), or tris [1-phenylisoquinolinato] iridium (III) (C₁₅NlrH₁₀).

11. An optical light guide, comprising a core including a fluorescent material and a cladding layer surrounding the core, wherein the fluorescent material is in a content of greater than 0.5 wt. % for a total weight of the core, wherein the optical light guide comprises a refractive index difference between the core and the cladding layer, wherein an absolute value of the difference is at least 0.1.

12. The optical light guide of claim 11, wherein the core comprises polystyrene, polyacrylate, polymethylmethacrylate, polyvinyltoluene, polyethylene naphthalate (PEN), or any combination thereof.

13. The optical light guide of claim 11, wherein the core has a refractive index of at least 1.45.

14. The optical light guide of claim 11, wherein the cladding layer has a refractive index less than the refractive index of the core.

15. The optical light guide of claim 11, wherein the cladding layer has a refractive index of at most 1.40.

16. The optical light guide of claim 11, wherein the fluoropolymer comprises ethylene tetrafluoroethylene (ETFE), perfluoroalkoxy (PFA), polytetrafluoroethylene (PTFE), or any combination thereof.

17. The optical light guide of claim 11, wherein the optical light guide has a light trapping efficiency of at least 15%.

18. The optical light guide of claim 11, wherein the optical light guide is embedded within a security document.

19. The optical light guide of claim 18, wherein a light-exiting end is aligned with an edge of the security document, and a radiation-receiving end is aligned with an opposite edge of the security document.

20. An anti-counterfeiting paper, comprising a layer structure; and an optical light guide within the layer structure, wherein the optical light guide comprises a core including a fluorescent material, wherein the fluorescent material is in a content of greater than 0.5 wt. % for a total weight of the core.
